(19) United States
(12) Patent Application Publication
(10) Pub. No.: US 2003/0063383 A1
(43) Pub. Date: Apr. 3, 2003

(54) Software out-of-focus 3D method, system, and apparatus

(76) Inventor: Bryan L. Costales, Boulder, CO (US)

Correspondence Address: SHERIDAN ROSS PC, 1560 BROADWAY, SUITE 1200, DENVER, CO, 80202

(21) Appl. No.: 10/260,865

(22) Filed: Sep. 27, 2002

Related U.S. Application Data
(63) Continuation-in-part of application No. 09/775,887, filed on Feb. 2, 2001.
(60) Provisional application No. 60/180,038, filed on Feb. 3, 2000.

(51) Int. Cl. G02B 23/00

(52) U.S. Cl. 359/464; 359/462; 359/426

(57) ABSTRACT

A method, system, and apparatus are disclosed for producing enhanced three dimensional effects. The invention emulates physical processes of focusing wherein objects in the foreground and the background are in varying degrees out-of-focus and represented differently to each of a viewer's eyes. In particular, the invention divides out-of-focus light representations so that different partitions of such a division are viewed by a viewer's right eye as compared to what is viewed by the viewer's left eye, and so that the identical in-focus representation is viewed by both eyes. Thus, the invention interposes novel processing between a determination as to what to render in a synthetically produced three dimensional space and the actual rendering thereof, wherein the novel processing produces stereoscopic views from a two dimensional view by utilizing information about the relation of light sources in the three dimensional space to the in-focus plane in the space.

### CROSS REFERENCE TO RELATED APPLICATION

The present application is a continuation-in-part of U.S. patent application Ser. No. 09/775,887, filed Feb. 2, 2001, entitled “SOFTWARE OUT-OF-FOCUS 3D METHOD, SYSTEM AND APPARTUS” (As Amended), which claims the benefits under 35 U.S.C. §119 of U.S. Provisional Patent Application Serial No. 60/180,038, filed Feb. 3, 2000, entitled “SINGLE-LENS 3D SOFTWARE METHOD, SYSTEM AND APPARATUS” to Costales and Flynt, which is incorporated herein by this reference. The present application is also related to U.S. patent application Ser. No. 09/354,230, filed Jul. 16, 1999; U.S. Provisional Patent Application Serial No. 60/166,902, filed Nov. 22, 1999; U.S. patent application Ser. No. 09/664,084, filed Sep. 18, 2000; U.S. Provisional Patent Application Serial No. 60/245,793, filed Nov. 3, 2000; U.S. Provisional Patent Application Serial No. 60/261,236, filed Jan. 12, 2000; U.S. Provisional Patent Application 60/190,459, filed Mar. 17, 2000; and U.S. Provisional Patent Application Serial No. 60/222,901, filed Aug. 3, 2000, all of which are incorporated herein by reference.

### BACKGROUND OF THE INVENTION

Many methods, systems, and apparatuses have been disclosed to provide computer generated graphical rendering scenes wherein depth information for objects in the scenes is used as a part of the software generation of the scene. Among the techniques in common use are:

(a) shadowing to convey background depth, wherein shadows cast by objects in the scene provide the viewer with information as to the distance to each object,

(b) smearing to simulate foreground and background out-of-focus areas, and

(c) computed foreground and background out-of-focus renderings modeled on physical principles such as graphical representations of objects in a foggy scene as in U.S. Pat. No. 5,724,561, and

(d) reduction of resolution to simulate foreground and background out-of-focus areas.

It is further known that there are graphics systems which provide a viewer with visual depth information in scenes by rendering 3D or stereoscopic views, wherein different views are simultaneously (i.e., within the limits of persistence of human vision) presented to each of the viewer's eyes. Among the techniques in common use for such 3D or stereoscopic rendering are edge detection, motion following, and completely separately generated ocular views. Note that the scenes rendered by the techniques (a)-(d) above give a viewer only indications of scene depth, but there is no sense of the scenes being three dimensional due to a viewer's eyes receiving different scene views as in stereoscopic rendering systems. Alternatively, the 3D or stereoscopic graphic systems require stereoscopic eye wear for a viewer. In other scene viewing systems, three dimensional effects can be created from a two dimensional scene by modifying the aperture stop of a physical lens system so that the aperture stop is vertically bifurcated to yield, e.g., different left and right scene views wherein a different one of the scene views is provided to each of the viewer's eyes. In particular, the effect of bifurcating the aperture stop vertically causes distinctly different out-of-focus regions in the background and foreground display areas of the two scene views, while the in-focus image plane of each scene view is congruent (i.e., perceived as identical) in both views. One of the advantages of this physical method is that it produces an image the can be viewed comfortably in 2D without eye-wear and in 3D with eye-wear. One of the advantages of modeling this physical method with a software method is that animated films can be created which can also be viewed comfortably in 2D without eye-wear and in 3D with eye-wear.

It would be desirable to have a simple graphical rendering system that allows a viewer to clearly view the same scene or presentation with or without stereoscopic eye-wear, wherein techniques such as (a)-(d) above may be presented differently depending on whether the viewer is wearing stereoscopic eye-wear or not. In particular, it would be desirable for the viewer to have a more pronounced sense of visual depth in the scene or presentation when such stereoscopic eye-wear used.

### SUMMARY OF THE INVENTION

The present invention is a method and apparatus for allowing a viewer (also denoted a user herein) to clearly view the same computer generated graphical scene or presentation with or without stereoscopic eye-wear, wherein techniques such as (a)-(d) above may be presented differently depending on whether the viewer is wearing stereoscopic eye wear or not. In particular, the present invention provides the user with a more pronounced sense of visual depth in the scene or presentation when such stereoscopic eye-wear used, but the same scene or presentation can be concurrently and clearly viewed without such eye-wear.

In one embodiment, the present invention achieves a stereoscopic effect by rendering points or subparts of an image located behind or in-front of an object plane as out-of-focus using pixels on a display based on offset information associated with the point(s). A point is deemed to be out-of-focus if an offset distance associated with the point is more than a selected threshold. Each point that is in-focus (or has an offset distance below a selected threshold) is displayed to both eyes. Each pixel, that represents an out-of-focus point (whether in the background or foreground), is defocused by replacing each such pixel with two or more pixels of reduced or different color intensity. Each pixel that represents an out-of-focus point in the background has its out-of-focus rendering displayed as the left half to the right eye and the right half to the left eye. Each pixel that represents an out-of -focus point in the foreground has its out-of-focus rendering displayed as the left half to the left eye, and the right half to the right eye.

In this methodology, the image is initially a focus representation of the object. To generate 3D, offset distances from the image plane associated with points in the image are used to defocus the points. As points are defocused, out-of-focus points can overlap in-focus points as well as one another. Pixel sets associated with each point, whether in-focus or out-of-focus, are then used to generate image information in a common set of pixels in an image plane for display to a viewer.

As used herein, “focus” refers to the point where rays of light come together or the point from which they spread or seem to spread. Specifically, in optics “focus” refers to the point where rays of light reflected by a mirror or refracted by a lens meet (called “real focus”) or the point where they would meet if prolonged backward through the lens or mirror (called “virtual focus”). As will be appreciated, a lens has a property called focal length or distance, which is the distance from the optical center of the lens to the point where the light rays converge (intersect). Thus, “in-focus” refers to the portion of the image represented by light focused on an image plane. “Out-of-focus” refers to the portion of the image represented by light not focused on the image plane. These definitions are consistent with the Lagrange, or the Smith Holmholtz theorem (Lens Design Fundamentals, Rudolf Kingslake, Academic Press, 1978, page 47). “Image” refers to an imitation, representation, or rendering of an object (a person or thing) produced by reflection from a mirror, refraction through a lens, computer generation, and the like. “Image plane” refers to a plane in which a selected portion of the image is focused. In a lens system, for example the image plane is typically the focal plane of one or more lenses in the lens system.

As used herein, “defocusing” or “to defocus” means at a very high level to alter the visual presentation of an image so that the image appears to a viewer to be at a lower resolution, fogged or foggy, dimmed or grayed out, or visually out-of-focus in a physical sense. In one configuration, defocusing, as herein described, means to replace the image information contained in a single pixel location with image information contained by at least two new pixels and to place or locate the two new pixels such that at least one is at the same pixel location as was the original pixel. Typically, the greater the number of pixels used to replace the single original pixel, the more out-of-focus that pixel location will appear and so, by implication, the further from the image plane the point represented by that pixel must be. As can be appreciated, defocusing is a repetitive process involving pixels at many locations throughout an image. The process of defocusing will typically cause those new pixels required for defocusing to be placed at pixel locations that may already contain other image information. When such overlapping situations arise, averaging or other mathematical computations can be performed to yield a final value for any such pixel when any such new pixels overlap it. Defocusing is not necessarily a process applied only to existing image information. New, heretofore non-existent images may be generated algorithmically and may be defocused as a part of that generation.

In one implementation of the embodiment, a plurality of pixels are each assigned image information corresponding to the image of an object. The image information in each pixel typically includes a color intensity and distance or offset from a selected image plane. The pixels are arranged in a two- three-, or four-dimensional matrix of rows and columns, and each pixel has an assigned position (e.g., row and column numbers) in the matrix. Foreground out-of-focus image information is assigned to a foreground pixel set; background out-of-focus image information is assigned to a background pixel set; and in-focus image information is assigned to an in-focus pixel set. To provide 3D, first parts or subsets of the foreground and/or background pixel sets are presented to one eye during a first time interval and second, different parts or subsets of the foreground and/or background pixel sets are presented to the other eye during a second, different (partially overlapping or non-overlapping) time interval. The rule(s) used for dividing the background pixel and foreground pixel sets into first and second subsets depend on the application. For example, the first and second pixel subsets can be left and right halves of the corresponding pixel set (which do not need to be mirror images of one another), upper and lower halves of the corresponding pixel set, or otherwise defined by a virtually endless number of other dividing lines, such as at nonorthogonal acute and/or obtuse angles to the horizontal and vertical. Although not required for generation of a 3D image, common in-focus image information (or the in-focus pixel set) may be presented to both eyes during both the first and second time intervals. To realize stereoscopic viewing, the spatial locations of the pixels in the first and second parts or subsets of the foreground pixel set and in the first and second parts or subsets of the background pixel set are maintained the same, both in absolute (relative to a defined point or plane) and relative (relative to adjacent pixels) terms. In other words, the spatial locations of the pixels in the left and right eye views are congruent or aligned or telecentric, e.g., the various pixels during image processing that are associated with selected image information (e.g., a pairing of color intensity and offset distance) have the same spatial locations (e.g., same row and column designations). Parallactic offsets and stereoscopic views are generated not by shifting of the spatial locations of the pixels but by subtracting first out-of-focus information from a first (eye) view and second out-of-focus information from a second (eye) view, or by creating first out-of-focus information for display to a first (eye) and second out-of-focus information for display to a second (eye) view.

The method of this present invention can avoid the complicated computations needed to shift pixels. It produces an image that can be comfortably viewed in 2D without eyewear, and effectively viewed in 3D with eyewear. Unlike prior art, this method produces a 2D image that does not degrade with channel cross-talk, and so can be comfortably shown in 2D. Unlike the prior art, this method further insures that the in-focus image always appears at the plane of the display, which eliminates many, if not all, of the drawbacks of prior art (key stoning, out-of-plane display, scene differences at the display edge, etc.) all of which lead to viewer fatigue and nausea. The images produced with this method can be comfortably viewed for prolonged periods without discomfort.

The stereoscopic imaging techniques disclosed herein can be utilized with any image acquisition device as well as with any algorithm for generating image information. For example, the techniques can be used with any of the imaging devices described in U.S. patent application Ser. No. 09/354,230, filed Jul. 16, 1999; U.S. Provisional Patent Application Serial No. 60/166,902, filed Nov. 22, 1999; U.S. patent application Ser. No. 09/664,084, filed Sep. 18, 2000; and U.S. Provisional Patent Application Serial No. 60/245,793, filed Nov. 3, 2000; U.S. Provisional Patent Application Serial No. 60/261,236, filed Jan. 12, 2000; U.S. Provisional Patent Application Serial No. 60/190,459, filed Mar. 17, 2000; and U.S. Provisional Patent Application Serial No. 60/222,901, filed Aug. 3, 2000, all of which are incorporated herein by reference. In the event that the acquired image is in analog form, any number of known processes may be employed to digitize the image for processing using the techniques disclosed herein.

To facilitate a greater appreciation and understanding of the present invention, the following U.S. Patents are incorporated herein by this reference:

| | | | |
|---|---|---|---|
| 3,665,184 | 5/1972 | Schagen | 378/041 |
| 4,189,210 | 2/1980 | Browning | 359/464 |
| 4,835,712 | 5/1989 | Drebin | 345/423 |
| 4,901,064 | 2/1990 | Deering | 345/246 |
| 4,947,347 | 8/1990 | Sato | 345/421 |
| 5,162,779 | 11/1992 | Lumeisky | 340/709 |
| 5,402,337 | 3/1995 | Nishide | 345/426 |
| 5,412,764 | 5/1995 | Tanaka | 345/424 |
| 5,555,353 | 9/1996 | Shibazaki | 345/426 |
| 5,616,031 | 4/1997 | Logg | 434/038 |
| 5,883,629 | 6/1996 | Johnson | 345/419 |
| 5,724,561 | 3/1998 | Tarolli | 345/523 |
| 5,742,749 | 4/1998 | Foran | 345/426 |
| 5,798,765 | 8/1998 | Barclay | 345/426 |
| 5,808,620 | 9/1998 | Doi | 345/426 |
| 5,809,219 | 9/1998 | Pearce | 345/426 |
| 5,838,329 | 11/1998 | Day | 345/426 |
| 5,883,629 | 3/1999 | Johnson | 345/419 |
| 5,900,878 | 5/1999 | Goto | 345/419 |
| 5,914,724 | 6/1999 | Deering | 345/431 |
| 5,926,182 | 7/1999 | Menon | 345/421 |
| 5,926,859 | 7/1999 | Meijers | 345/419 |
| 5,936,629 | 8/1999 | Brown | 345/426 |
| 5,977,979 | 11/1999 | Clough | 345/422 |
| 6,018,350 | 1/2000 | Lee | 345/426 |
| 6,064,392 | 5/2000 | Rohner | 345/426 |
| 6,078,332 | 6/2000 | Ohazama | 345/426 |
| 6,081,274 | 6/2000 | Shiraishi | 345/426 |
| 6,147,690 | 11/2000 | Cosman | 345/431 |
| 6,175,368 | 1/2001 | Aleksie | 245/430 |

Further benefits and features of the present invention will become evident from the accompanying figures and the Detailed Description hereinbelow.

### BRIEF DESCRIPTION OF THE DRAWINGS

FIG. 1 illustrates that optically out-of-focus portions of a scene that are in the background do not differ from out-of focus portions of a scene that are in the foreground.

FIG. 2 shows that a single lens 3D produces out-of-focus areas that differ between the left and right views and between the foreground and background.

FIG. 3 shows that the method of the present invention can interpose a decision between the decision to render and the process of rendering.

FIG. 4 shows that the method cannot be circumvented.

FIG. 5 shows a logic diagram which describes the system and apparatus.

FIG. 6 is a programmatic representation of the advisory computational component 19 shown here in the C programming language.

FIGS. 7A and 7B is a flowchart showing, at a high level, the processing performed by the present invention.

FIG. 8 illustrates the division of a (model space) pixel's out-of-focus image extent (on the image plane), wherein this extent is divided vertically (i.e., traversely to the line between a viewer's eyes) into greater than two (and in particular four) portions for displaying these portions selectively to different of the viewer's eyes.

FIG. 9 illustrates a similar division of a (model space) pixel's out-of-focus image extent; however, the division of the present figure is horizontal rather than vertical (i.e., substantially parallel to the line between a viewer's eyes).

FIG. 10 illustrates a division of a (model space) pixel's out-of-focus image extent wherein the division of this extent is at an angle different from vertical (FIG. 8) and also different from horizontal (FIG. 9).

FIG. 11 illustrates an in-focus representation of a point as a pixel on a display, and two out-of-focus representations of points as pixel sets on a display.

FIG. 12 illustrates an in-focus representation of a point as a pixel on a display, and two halves of out-of-focus representations of points as pixel sets on a display, as viewed by the right eye of the viewer.

FIG. 13 illustrates an in-focus representation of a point as a pixel on a display, and two halves of out-of-focus representations of points as pixel sets on a display, as viewed by the left eye of the viewer.

FIG. 14 illustrates, at a high level, the system of which the processing performed by the present invention is a part; including the image, the processor, and the display.

FIG. 15 is the same as FIG. 2, except that FIG. 15 illustrates the in-focus point and out-of-focus regions as an in-focus pixel representing the in-focus point, and as sets of pixels representing the out-of-focus points.

FIG. 16 illustrates one example of converting a pixel representing an in-focus point into a set of pixels representing an out-of-focus region, and the decision to reverse or not the out-of-focus region's pixels.

FIG. 17 illustrates the object plane in object space (model space) being mapped to the image (display) plane.

FIG. 18 illustrates the image plane of FIG. 17 with the background and foreground pixels rendered as out-of-focus regions, and how those out-of-focus regions are displayed to the left and right eyes.

FIG. 19 illustrates PRIOR ART method of producing a 3D image by shifting pixels.

FIG. 20 illustrates the method of dealing with overlapping pixels.

### DETAILED DESCRIPTION OF THE INVENTION

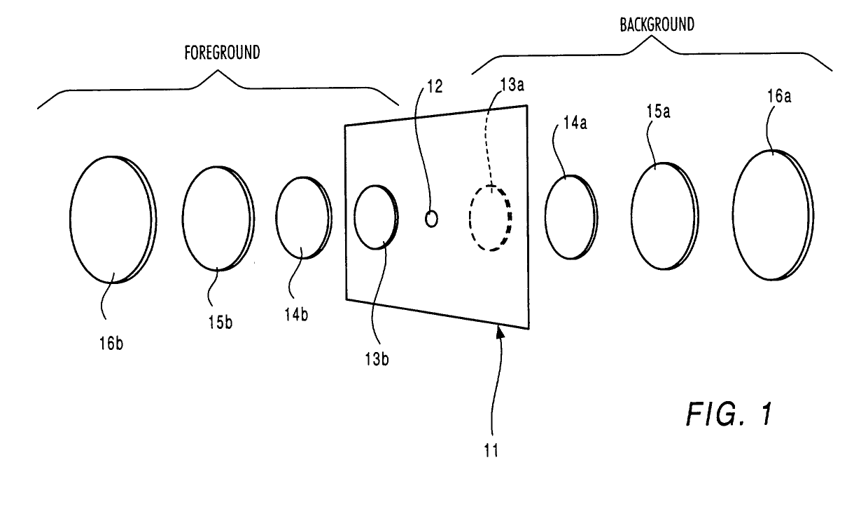

Given, e.g., a point light source (not shown, and more generally, an object) to be imaged by a lens system (not shown), FIG. 1 shows an in-focus image 12 of the point light source, wherein the image 12 is on an image plane 11. Other images of the point light source may be viewed on planes that are parallel to the image plane 11 but at different spatial offsets from the image plane 11. Images 13A through 16B depict the images of the point light source on such offset planes (note, that these images are not shown their respective offset planes; instead, the images are shown in the plane of the drawing to thereby better show their size and orientation to one another). In particular, offset planes of substantially equal distance in the foreground and the background from the image plane typically have substantially the same out of focus image for a point light source. Moreover, given an object plane (not shown) which, by definition, is substantially normal to the aperture stop of the lens system, and contains the portion of the image that is in-focus on the image plane 11, a different point light source on the opposite side of the object plane from the lens system (i.e., in the “background” of a scene displayed on the image plane 11) will project to a point image (i.e., focus) ahead of the image plane 11 (i.e., on the side of the image plane labeled BACKGROUND). As used herein, an “object plane” refers to the plane of focus in an optical system, or the X/Y plane in model space, where the object plane is usually perpendicular to the optical axis (the Z axis) and generally parallel to a projected image plane. Thus, the image of such a background point on the image plane 11 will be out-of-focus. Alternatively, a point light source on the same side of the object plane (i.e., in the “foreground” of the scene displayed on the image plane 11) will project to a point image behind the image plane (i.e., on the side of the image plane labeled FOREGROUND). Thus, the image of such a foreground point light source in the image plane 11 will be similarly out-of-focus, and more particularly, foreground and background objects of a equal offset from the object plane will be substantially equally out of focus on the image plane 11. For example, the images 13A through 16B show the size of the representation of various point light sources in the foreground and the background as they might appear on the image plane 11 (assuming the point light sources for each image 13A and 13B are the same distance from the object plane, similarly for the pairs of images 14A and B, 15A and B, and, 16A and B).

When, a background or foreground point is out-of-focus, but insufficiently out-of-focus for the human eye to perceive it as out-of-focus, it is denoted herein as “physically out-of-focus”. Note that image points 13A and 13B are to be considered as only physically out of focus herein. When a background and foreground point is sufficiently out-of-focus for the human eye to perceive it as out-of-focus, it is denoted herein as “visually out-of-focus”. Typically, “visually out-of-focus” image information is distinguished from “visually in-focus” information by specifying an offset distance from the image plane (which depends on the type of lens system used or replicated) as the threshold. Image information having an offset distance equal to or greater than the selected offset distance is “visually out-of-focus” while image information having an offset distance less than the selected offset distance is “visually in-focus”. Note that images 14A through 16B are to be considered as visually out of focus herein. Furthermore, note that as a point in the three dimensional space (i.e., model or object space) moves further away from the object plane, its projections onto the image plane 11 become more and more out-of-focus on the image plane.

When a user is wearing eye-wear (or is viewing a display-device that displays a different view to each eye) according to the present invention, wherein different digital images can be substantially simultaneously presented to each of the user's eyes (i.e., typically the time between presentation of the left- and right-eye views is within limits of image persistence of the human eye and more typically no more than about 5 milliseconds, although a slower rate may be utilized to enable detection of implementation defects), the present invention provides an improved three dimensional effect by performing, at a high level, the following steps:

Step (a) determining an image, IM, of the model space wherein the image of each object in IM is in-focus regardless of its distances from the point of view of the viewer,

Step (b) determining an object plane coincident with the portion of model space that will the in-focus plane,

Step (c) determining the out-of-focus image extent of each pixel in IM based on its distance from the object plane, and assign to each such pixel a value based on its being in front of or behind the object plane relative to the point of view of the viewer,

Step (d) dividing into two image portions, e.g., image halves, the image extent of each pixel determined in step (c) that is visually out-of-focus,

Step (e) for each pixel image extent divided in (d) into first and second halves:

(i) displaying the out-of-focus first image half to a first of the user's eyes, while simultaneously or sequentially displaying the second image half to the second of the user's eyes, and

(ii) during the displaying steps of(i) above, displaying the in-focus image to both eyes.

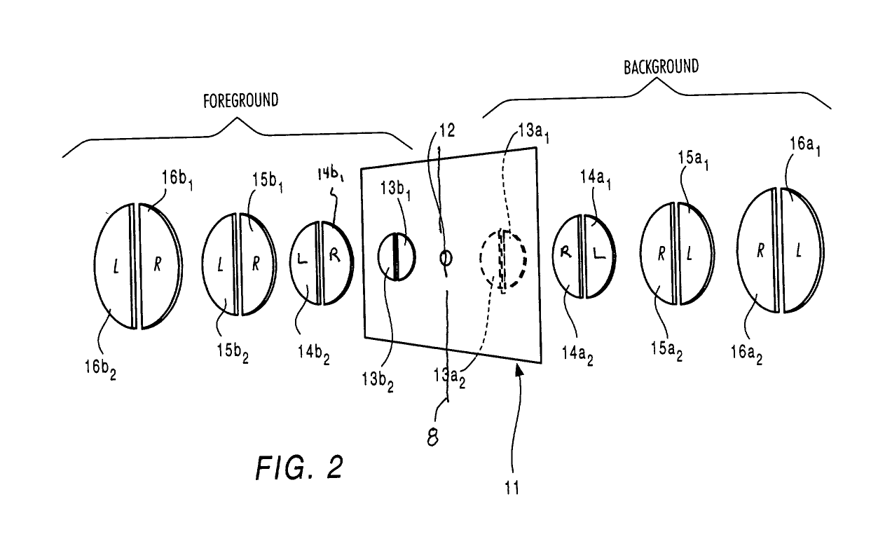

FIG. 2 shows each of the out of focus point images 13A through 16B of FIG. 1 divided, wherein the divisions are intended to represent the divisions resulting from step (d) above. In particular, the divisions of the point images 13A through 16B are along an axis 8 that is both parallel to the image plane 11 and perpendicular to a line between a viewer's eyes. Thus, the image halves 13A₁ and 13A₂ are the two image halves (left and right respectively) of the background image point 13A. The image halves 13B₁ and 13B₂ show the divided left and right halves respectively of the foreground point image 13B wherein 13B₁ and 13B₂ are physically out-of-focus substantially the same as image halves 13A₁ and 13A₂. The left and right image halves 14A₁ and 14A₂ are visually out-of-focus and accordingly these image halves will be displayed selectively to the viewer's eyes as in step (e) above. That is, each of the viewer's eyes sees a different one of the image halves 14A₁ and 14A₂, and in particular, the viewer's right eye views only the left image half 14A₁ while the viewer's left eye views only the right image half 14A₂ as is discussed further immediately below. Thus, as indicated by the letter labels (FIG. 2) inside each half, the right eye view will be presented with the out-of-focus halves labeled with the letter “R” and the left eye view will be presented with the out-of-focus halves labeled with the letter “L”. Note that the side presented to an eye view is reversed depending on whether the foreground or background is being rendered.

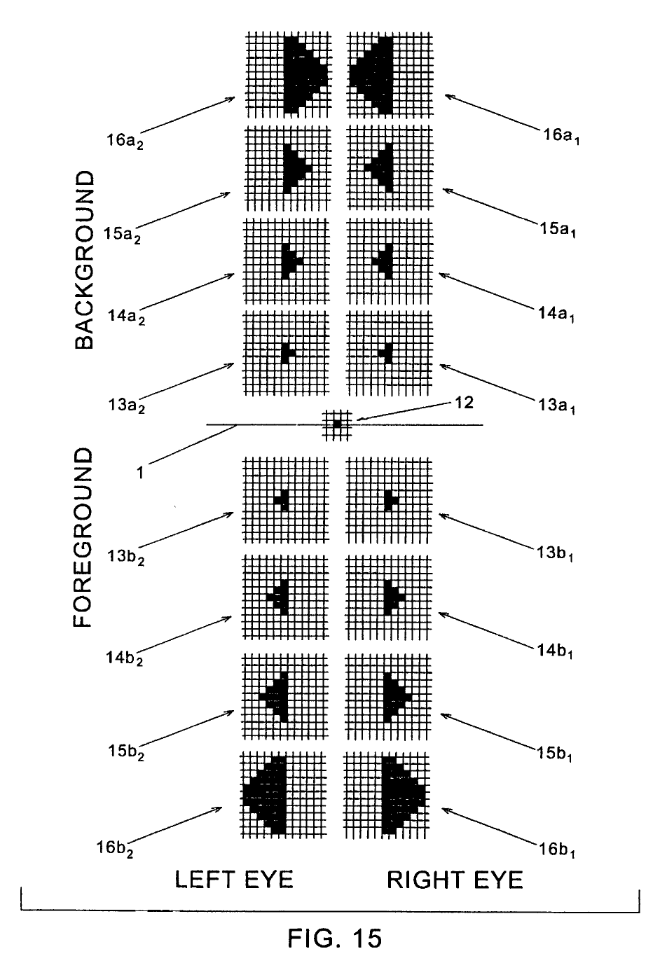

FIG. 15 shows each of the out of focus point images 13a₁ through 16b₂ of FIG. 1 divided, wherein the divisions are intended to represent the divisions resulting from step (d) above, but shows them as pixel representations of the in-focus and out-of-focus points as those pixel representations would appear on a display.

Thus, in addition to the Steps (a) through (e) above, the present invention also performs an additional step (denoted herein as Step (e.i)) of determining which of the viewer's eyes is to receive each of the visually out-of-focus image halves as represented by pixels and pixel sets. In this way the present invention provides the viewer with additional visual effects for indicating whether a visually out-of-focus portion of a scene or presentation is in the background or in the foreground. That is, for each pixel of IM from which a visually out-of-focus background portion of a scene is derived, the corresponding out-of-focus image halves are selectively displayed so that the left image half is displayed only to the viewer's right eye, and the right image half is displayed only to the viewer's left eye. Moreover, for each pixel of IM from which a visually out-of-focus foreground portion of a scene is derived, the corresponding out-of-focus image halves are selectively displayed so that the left image half is displayed only to the viewer's left eye, and the right image half is displayed only to the viewer's right eye. Moreover, as an additional step (denoted herein as Step (e.ii)) for each pixel of IM from which a visually in-focus portion of a scene is derived, the corresponding in-focus image is displayed to both the viewer's eyes. Thus, for the left and right background image halves 14a₁ and 14a₂, as depicted in FIGS. 2 and 15, each respectively is presented solely to the viewer's left and right eyes, and for the image-plane image point 12, as depicted in FIGS. 2 and 15, each is presented to the both of the viewer's eyes.

It is important to note that the enhanced three dimensional rendering system of the present invention, provided by Steps (a) through (e) and (e.i) and (e.ii), can be used with substantially any lens system (or simulation thereof). Thus, the invention may be utilized with lens systems (or graphical simulations thereof) where the focusing lens is spherically based, anamorphic, or some other configuration. Moreover, in one primary embodiment of the present invention, scenes from a modeled or artificially generated three dimensional world (e.g., virtual reality) are rendered more realistically to the viewer using digital eye wear (or other stereoscopic viewing devices) allowing each eye to receive simultaneously or sequentially a different digital view of a scene.

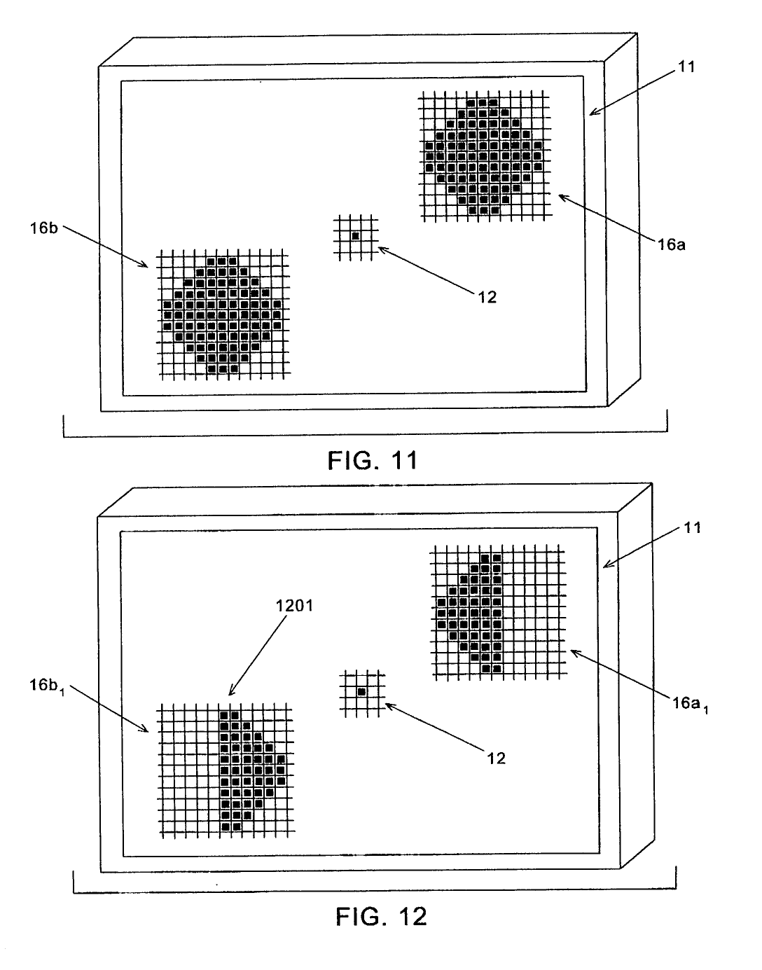

FIG. 11 shows the elements of a display as it would appear prior to steps (a) through (e) above. An in-focus point in IM displays as a pixel 12 on the display surface 11. A background point in IM displays as a pixel region (or set) 16a on the display surface. A foreground point in IM displays as a pixel region (or set) 16b on the display surface. Prior to steps (a) through (e) above, a display is generated that shows the foreground and background out-of-focus regions as identical and lacking in information that allows the viewer to differentiate between them.

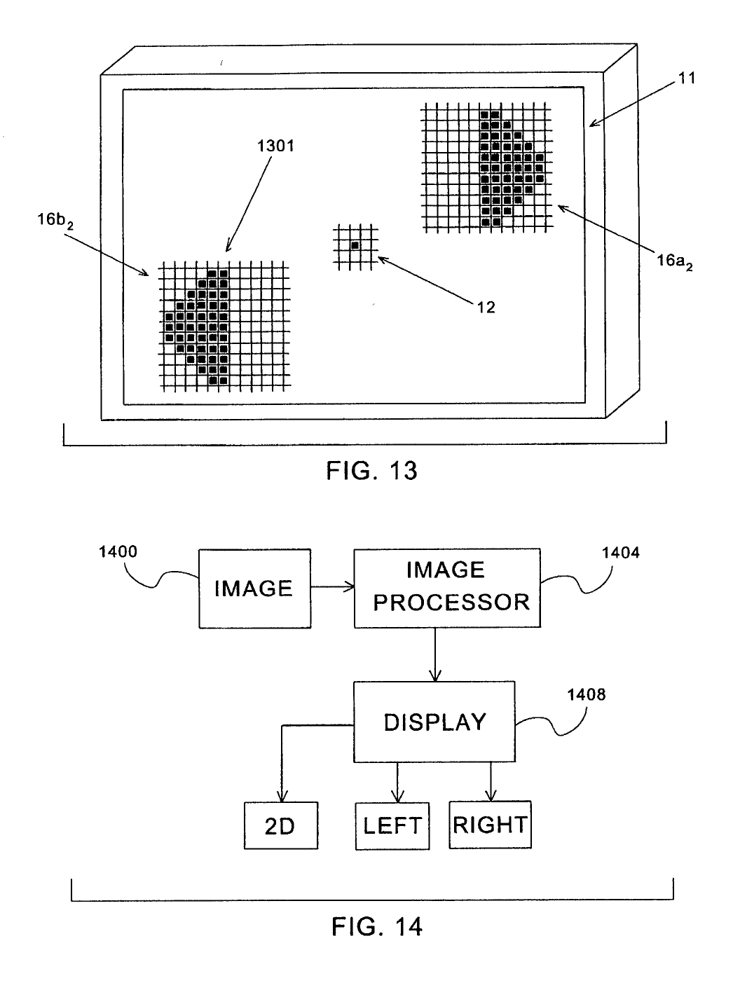

FIG. 12 shows the elements of a display as it would appear subsequent to steps (a) through (e) above, and as that display would be viewed by the viewer's right eye. An in-focus point in IM displays as a pixel 12 on the display surface 11 (identical for both the right and left eye views). A background point in IM displays as subset of a pixel region (or set) 16a₁ on the display surface. A foreground point in IM displays as a pixel region (or set) 16b₁ on the display surface. Subsequent to steps (a) through (e) above, a display is generated that shows the foreground and background out-of-focus regions to the right eye as different from each other and as different from the left eye view of FIG. 13.

FIG. 13 shows the elements of a display as it would appear subsequent to steps (a) through (e) above, and as that display would be viewed by the viewer's left eye. An in-focus point in IM displays as a pixel 12 on the display surface 11 (identical for both the right and left eye views). A background point in IM displays as subset of a pixel region (or set) 16a₂ on the display surface. A foreground point in IM displays as a pixel region (or set) 16b₂ on the display surface. Subsequent to steps (a) through (e) above, a display is generated that shows the foreground and background out-of-focus regions to the left eye as different from each other and as different from the right eye view of FIG. 13.

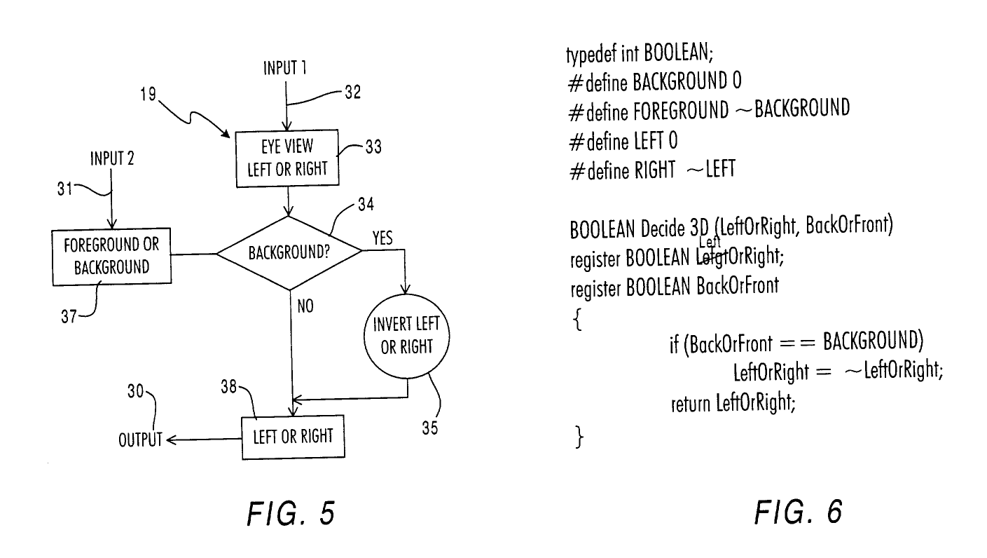

The IM (IMAGE) 1400 of FIG. 14 is processed by an image processor 1404 that implements at least steps (a) through (e) above to yield pixel representations suitable for display with display 1408, either simultaneously or sequentially to the left (LEFT) and right (RIGHT) eyes of the viewer for a 3D display, or simultaneously to both eyes of the viewer (2D) for a 2D-compatible display. The image processor 1404 includes, in one configuration, the components depicted in FIG. 5 (namely the logic module 34 and registers 33, 37, and 38) and one or more buffers or data stores to store the input and/or output.

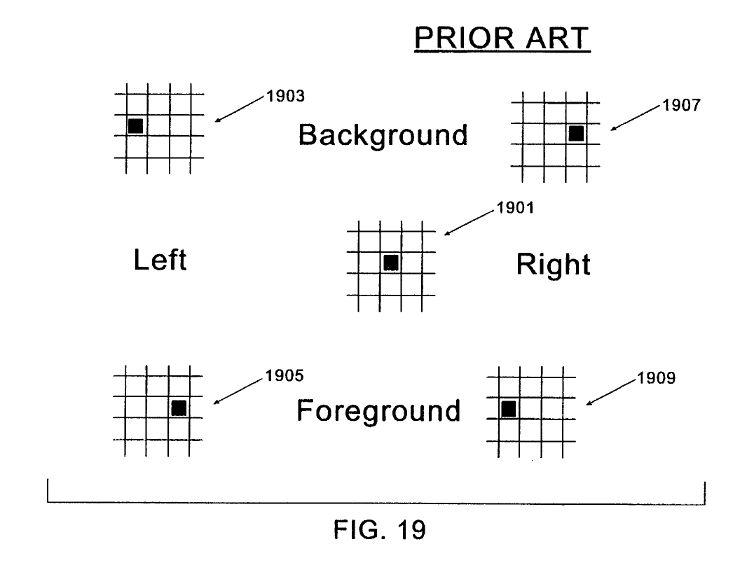

The method herein described is significantly different than that described by PRIOR ART. FIG. 19 illustrates the prior art method of shifting pixels to achieve a 3D image. Pixel 1901 shows the position it would occupy if it had no Z-axis displacement. For the left eye view, if pixel 1901 were in the background, it would be shifted left as at 1903, and if pixel 1901 were in the foreground, it would be shifted right as at 1905. For the right eye view, if pixel 1901 were in the background, it would be shifted right as at 1907, and if pixel 1901 ere in the foreground, it would be shifted left as at 1909.

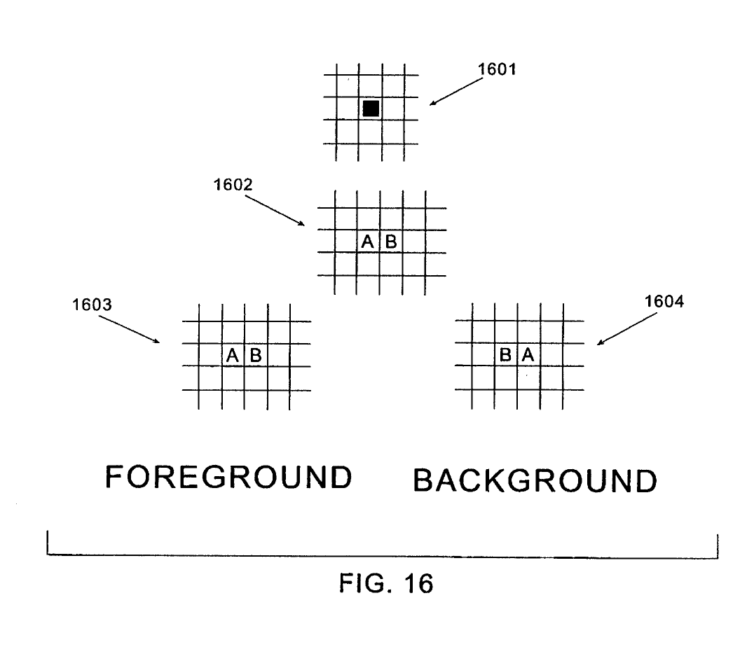

The method herein described is distinctly different, as shown in the following steps and in FIG. 16. An out-of-focus region, at a high level, may be generated from any given pixel and displayed to produce a 3D effect, using the following steps:

Step (f) replacing the pixel with at least two pixels, wherein the new pixels contribute a total color intensity to the display that is no greater than (and typically less than) the color intensity of the original pixel.

Step (g) determining if the original pixel is a member of a background set, and if it is, reversing the order of replacement of the original pixel with the at least two new pixels.

Step (h) displaying the left pixel to the left eye and the right pixel to the right eye.

FIG. 16 further illustrates steps (f) through (h) above. A pixel that is one of a set of pixels 1601 appears on a display (not shown) with a given color intensity. To render that pixel as an out-of-focus region, it is converted into at least two pixels 1602, wherein the sum of the color intensities of the at least two new pixels is no greater than the color intensity of the original pixel 1601. The color intensities of the two new pixels can be determined by techniques known to those of ordinary skill in the art. For example, the color intensities can be determined by dividing the color intensity of the original pixel 1601 by two, and assigning that result to each of the new pixels 1602. The two new pixels 1602 are labeled A and B for clarity of the description to follow. The position of the original pixel 1601 as it relates to the IM is determined to be either in the BACKGROUND or in the FOREGROUND. If the position of the original pixel is in the BACKGROUND, the at least two new pixels 1602 are rendered in the opposite order, yielding the orientation as shown in 1604. If the position of the original pixel is in the FOREGROUND, the orientation of the at least two new pixels is not changed, as shown in 1603. FIGS. 11 through 13 further illustrate this process (without the A and B labels), and further illustrate that one pixel may be rendered as out-of-focus using more than two pixels. As shown in FIGS. 12 and 13, the portion of the out-of-focus area that is displayed to each eye may overlap with that displayed to the other eye, as for example, FIG. 12 column of pixels 1201 overlaps with FIG. 13 column of pixels 1301, that is, while each eye views a separate display, both eyes may still share the central out-of-focus representation pixel views. The present invention is also not limited to selectively providing half-circles to the viewer's eyes. Various other out-of-focus shapes (other than circles) may be divided in step (d) hereinabove. In particular, it has been demonstrated in the physical world that many other shapes will also produce the desired three dimensional image production and perception. For example, instead of being circular, the out-of-focus shapes may be rectangular, elliptical, asymmetric, or even disconnected. Thus, such out-of-focus shapes need not be symmetric, nor need they model out-of-focus light sources from the physical world. Moreover, it is believed that one skilled in the graphics software arts will easily see that most any method for achieving a suitable out-of-focus effect can be divided in some suitable way to achieve a stereoscopic result (from a non-stereoscopic image), and any such division is within the scope of the present invention.

Moreover, note that in the dividing step (d) hereinabove, such left and right image “halves” need not be mirror images of one another. Furthermore, the left and right image halves need not have a common boundary. Instead, the right and left image halves may, in some embodiments, overlap, or have a gap between them.

Additionally, it is within the scope of the present invention to divide out-of-focus images and selectively display the resulting divided portions (e.g., image halves as discussed above) for only the foreground or only the background. Additionally, it is within the scope of the present invention to process only portions of either the background and/or the foreground such as the portions of a model space image within a particular distance of the object plane. For example, in modeling certain real world effects in computational systems, it may be unnecessary (and/or not cost effective) to apply the present invention to all out-of-focus regions. Moreover, in Steps (a) through (e) and (el) hereinabove, the out-of-focus image extent may be determined from an area larger than a pixel and/or the image IM (Step (a) above) may include pixels that themselves include portions of, e.g., both the background and the foreground.

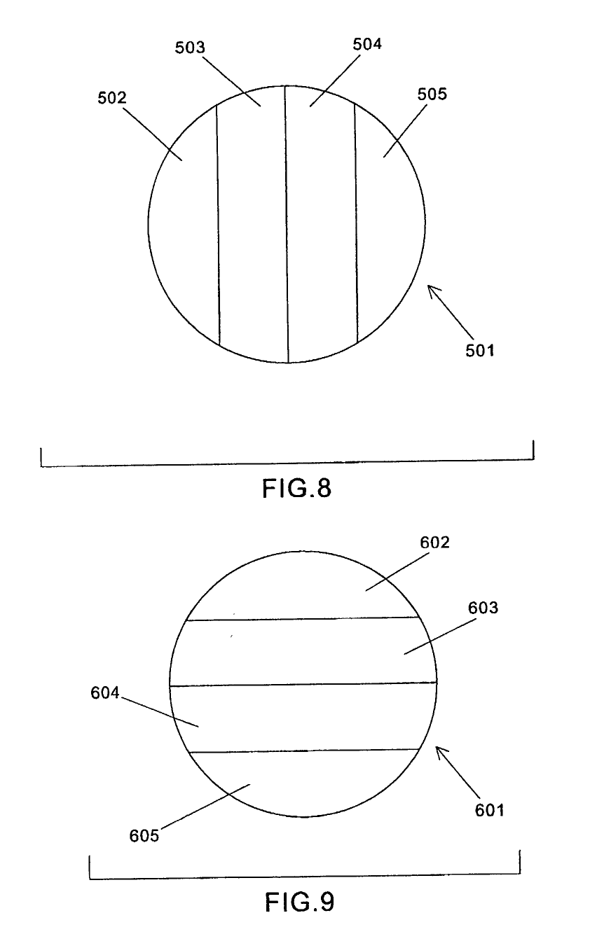

It is also worth noting that the present invention is not limited to only left and right eye stereoscopic views. It is well known that lenticular displays can employ multiple eye views. The division into left and right image halves as described hereinabove may be only a first division wherein additional divisions may also be performed. For example, as shown in FIG. 8, for each of one or more of the out-of-focus areas, such an area (labeled 501) can be divided into four vertical areas, thus creating the potential for four discrete views 502 through 505 for the pixel area 501 (instead of two “halves” as described hereinabove in Step (d)). Thus, those skilled in the software graphics arts will be readily able to extend the present invention to perform divisions (Step (d) hereinabove) to obtain as many out-of-focus image portions as are needed to satisfy particular display needs. Accordingly, the present invention includes substantially any number of vertical divisions of the image extents of pixels as in Step (d) above. Note that when there are multiple divisions in Step (d) above of an image extent of an IM pixel, then the rendering of the resulting image portions for enhanced three dimensional effects can be performed by an alternative embodiment of Step (e1) which receives three or more image portions of the out-of-focus IM pixel and then, e.g., performs the following substeps as referenced to FIG. 8:

1. For views V₁ through Vₙ (n>=2) of a pixel image extent obtained from dividing this extent (e.g., the views illustrated in FIG. 8 as views 502 through 505 with n=4), wherein these views correspond to multiple eye views from the viewer's far left most to the far right most field of view, determine whether a point for a view is a background or foreground point.

2. If the point for view Vₓ is a background point, return V₍ₙ₋ₓ₊₁₎. For example, a background point for view 505 would be 502.

3. If the point for view Vₓ is a foreground point, return Vₓ. For example, a foreground point for view 505 would be 505.

Additionally, note that horizontal divisions may also be provided in Step (d) above by embodiments of the invention, wherein the resulting horizontal “image portions” of the image extent of out-of-focus IM pixels are divided horizontally. In particular, such horizontal image portions, when selectively displayed to the viewer's eyes, can supply an enhanced three dimensional effect when a vertical head motion of the viewer is detected as one skilled in the art will understand. Note that for selective display of such horizontal image portions, Step (e1) may include the following substeps as illustrated by FIG. 9:

1. For views V₁ through Vₙ (n>=2) of a pixel image extent 601 obtained from dividing this extent (e.g., the views illustrated in FIG. 9 as views 602 through 605 with n=4), wherein these views correspond to multiple eye views from the viewer's top most to the bottom most field of view, determine whether a point for a view is a background or foreground point.

2. If the point for view Vₓ is a background point, return V₍ₙ₋ₓ₊1). For example, a background point for view 605 would be 602.

3. If the point for view Vₓ is a foreground point, return Vₓ. For example, a foreground point for view 605 would be 605.

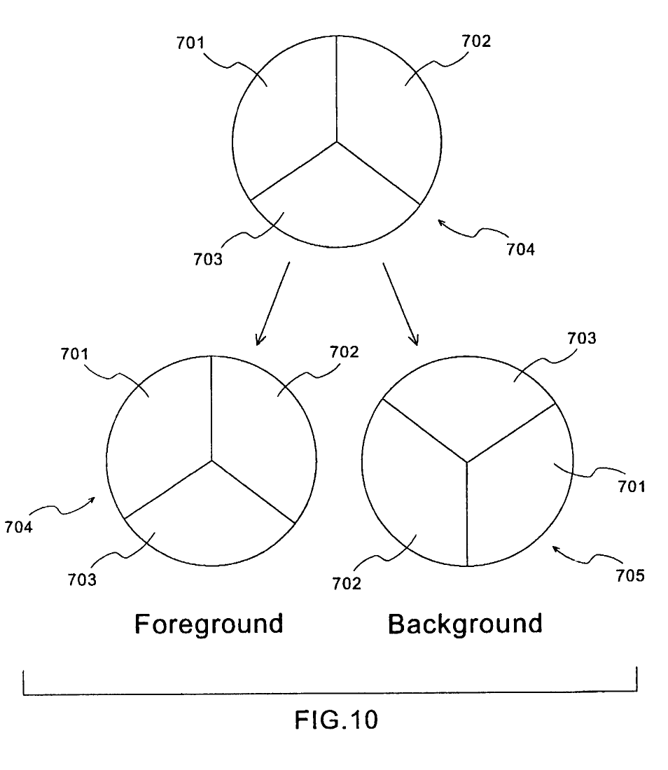

Moreover, it is within the scope of the present invention for Step (d) to divide IM out-of-focus pixels at other angles rather than vertical and horizontal. When Step (d) divides image extents at any angle, Step (e1) may include the following substeps, the general principals of which are illustrated in FIG. 10:

1. For views V₁ through Vₙ (n>=2) of a pixel image extent obtained from dividing this extent 704 (e.g., the views illustrated in FIG. 10 as views 701 through 703), wherein these views correspond to multiple eye views rotationally symmetric around a center, determine whether a point for a view is a background or foreground point.

2. If the point for view Vₓ is a background point, invert both horizontally and vertically the reference as at 705, and return Vₓ. For example, a background point for view 703 would be determined by rotating horizontally and vertically the reference at 704 to yield a new reference at 705, and then to return 703 relative to the new reference.

3. If the point for view Vₓ is a foreground point, return Vₓ. For example, a foreground point for view 703 would use the unrotated reference at 704 and would return 703 relative to that reference.

Furthermore, note that Step (d) may generate vertical, horizontal and angled divisions one the same IM out-of-focus pixels as one skilled in the art will understand

Furthermore, note that when reference views are used and their inverted and reflected counterparts, it is preferable that each reference be calculated once and buffered thereafter. It is also preferred when using such an approach, that an identifier for the reference be returned rather than the input and a reference.

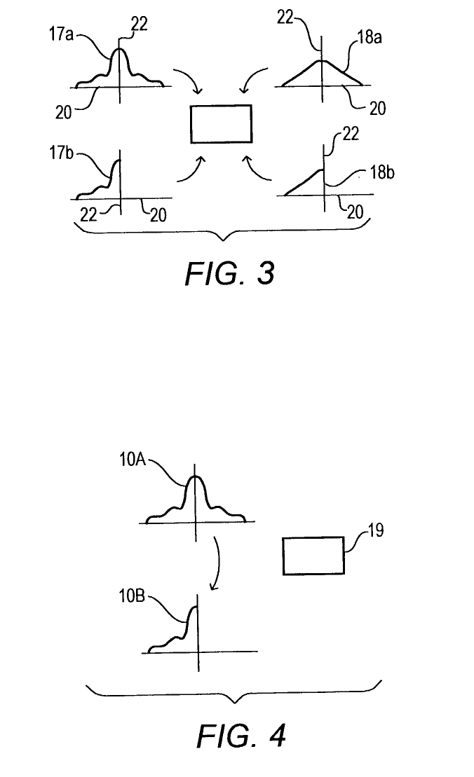

FIG. 3 shows graphical representations 17A and 18A of two formulas for determining how light goes out-of-focus as a function of distance from the object plane. In particular, the horizontal axis 20 of each of these graphs represents width of the out-of-focus area, and the vertical axis 22 represents the color intensity of the image. More precisely, the vertical axis 22 describes what may be considered as the clarity of an in-focus image on the image plane, and for each graph 17A and 18A, the respective portions to the left of its vertical axis is the graphical representation of how it is expected that light goes out-of-focus for a viewer's left eye while the portions to the right of the vertical axis is the graphical representation of how it is expected that light goes out-of-focus for a viewer's right eye. Note that the clarity measurement used on the vertical axes 22 may be described as follows: A narrow, tall graph represents a bright in-focus point, whereas a short, wide graph represents a dim, out-of-focus point. The vertical axis 22 in all graphs specifies spectral intensity values, and the horizontal axis 20 specifies the degree to which a point light source is rendered out-of-focus.

Referring now to graph 17A, this graph shows the graphic representation of the formula for a “circle of confusion” function, as one skilled in the optic arts will understand. The circle of confusion function can be represented by a formula that shows how light goes out-of-focus in the physical world. Referring now to graph 18A, this graph shows the graphic representation of a formula for “smearing” image components. Techniques that compute out-of-focus portions of images according to 18A are commonly used to suggest out-of-focus areas in a computer generated or computer altered image.

In the center of FIG. 3 is an advisory computational component 19 that maybe used by the present invention for rendering foreground and background areas: image out-of-focus, smeared, shadowed, or otherwise different from the in-focus areas of the image plane. That is, the advisory computational component 19 performs at least Step (e.i) hereinabove, or at least Step (g) hereinabove. In particular it is believed that such an advisory computational component 19, wherein one or more selections are made regarding the type of rendering and/or the amount of rendering for imaging the foreground and background areas, has heretofore not been disclosed in the prior art. That is, between the “intention” to render and the actualization of that rendering, such a selection process has here-to-fore never been made. In one embodiment of the advisory computational component, this component may determine answers to the following two questions for converting a non-stereoscopic view into a simulated stereoscopic view:

1. Is the point or area under query a background or a foreground point? and

2. Is the point or area under query a left eye view or a right eye view?

Accordingly, the advisory computational component 19 outputs a determination as to where to render the divided portions of step (d) above.

In one embodiment of the advisory computational component 19, this component may output a determination to render only the left image half (e.g., a semicircle as shown in FIGS. 2 and 15). Accordingly, graph 17B shows the graphic representation of the formula for a “circle of confusion” function, where the decision was to render only such a left image half. Additionally, graph 18B shows the graphic representation of a formula for smearing out-of-focus portions of an image, wherein the decision was to render only the left image half according to a smearing technique.

FIG. 4 depicts an intention to render an out-of-focus point or region according to circle of confusion processing (i.e. represented by graph 10A) to the viewer's left eye without using the advisory component 19. However, to selectively render different image halves to different of the viewer's eyes requires at least one test and one branch. It is within the scope of the present invention to include all such tests and branches inside the component 19, where those tests and branches are used to determine a mapping between foreground and background and right and left views, and to a rendering technique (e.g., circle of confusion or smearing) that is appropriate.

Note that there can be embodiments of the present invention wherein there is an attached data store for buffering or storing output rendering decisions generated by the advisory computational component 19, wherein such stored decisions can be returned in, e.g., a first-in-first-out order, or in a last-in-first-out order. For example, in multi-threaded applications, parallel processes may in a first instance seek to supply a module with points (e.g., IM pixels) to consider, and may in a second instance seek to use prior decided point information (e.g., image halves) to perform actual rendering.

FIG. 5 shows an embodiment of the advisory computational component 19 at a high level. In this figure, two inputs, INPUT 1 and INPUT 2, are combined logically to produce one output 30. The output 30 indicates whether a currently being processed out-of-focus image of a model space image point is to be rendered as a left or right out-of-focus area. The INPUT 1 at 32 has one of two possible values, each value representing a different one of the viewer's eyes to which the output 30 is to be presented. In one embodiment, INPUT 1 may be, e.g., a Boolean expression whose value corresponds to which of the left and right eyes the output 30 is to be presented. Upon receipt of the INPUT 1, the advisory computational component 19 stores it in input register 33.

INPUT 2 at 31 also has one of two possible values, each value representing whether the currently being processed out-of-focus image is substantially of a model space image point (IP) in the foreground or in the background. In one embodiment, INPUT 2 may be, e.g., a Boolean expression whose value represents the foreground or the background. Upon receipt of the INPUT 2, the advisory computational component 19 stores it in the input register 37.

Logic module 34 evaluates the two input registers, 33 and 37, periodically or whenever either changes. It either evaluates INPUT 2 in 37 for determining whether IP is: (i) a foreground IM pixel (alternatively, an IM pixel that does not contain any background), or (ii) an IM pixel containing at least some background. If the evaluation of INPUT 2 in register 37 results in a data representation for “FOREGROUND” (e.g., “false” or “no”), then INPUT 1 in register 33 is passed through to and stored in the output register 38 with its value (indicating which of the viewer's eyes IP is to be displayed) unchanged. If the evaluation in logic module 34 of INPUT 2 results in a data representation for “BACKGROUND” (e.g., “true” or “yes”), then component 35 inverts the value of INPUT 1 so that if its value indicates presentation to the viewer's left eye then it is inverted to indicate presentation to the viewer's right eye and vise versa. Subsequently, the output of component 35 is provided to output register 38.

Note that the logic module 34 may evaluate the two registers 33 and 37 whenever either one changes, or may evaluate the two registers 33 and 37 periodically without regard to change.

In one embodiment of the present invention for rendering of half-circular out-of-focus areas, the following table shows the four possible input states and their corresponding four output states.

I. Two Input Versus One Output Logic

| INPUT 1 | INPUT 2 | OUTPUT | SHAPE |
|---|---|---|---|
| Left | Foreground | Left | Left half circle |
| Right | Foreground | Right | Right Half circle |
| Left | Background | Right | Right half circle |
| Right | Background | Left | Left half circle |

In an alternative embodiment of the advisory computation component 19, note that INPUT 2 may have more than two values. For example, INPUT 2 may present one of three values to the input register 37, i.e., values for foreground, background, and neither, wherein the latter value corresponds to each point (e.g., IM pixel) on the object plane, equivalently an in-focus point. Because a point on the object plane is in-focus, there is no reason to render it in either out-of-focus form.

Still referring to FIG. 5, any change to the contents of one of the input registers 33 and 37 is immediately reflected by a corresponding change in the output register 38. Clearly, anyone skilled in the software arts will realize that such input/output relationships can be asynchronous or clocked, and that they can be implemented in a number of variations, any of which will produce the same decision for producing enhanced three dimensional effects.

FIG. 6 shows an embodiment of the advisory computational component 19 coded in the C programming language. Such code can be compiled for installation into hardware chips. However, other embodiments of the advisory computational component 19 other than a C language implementation are possible.

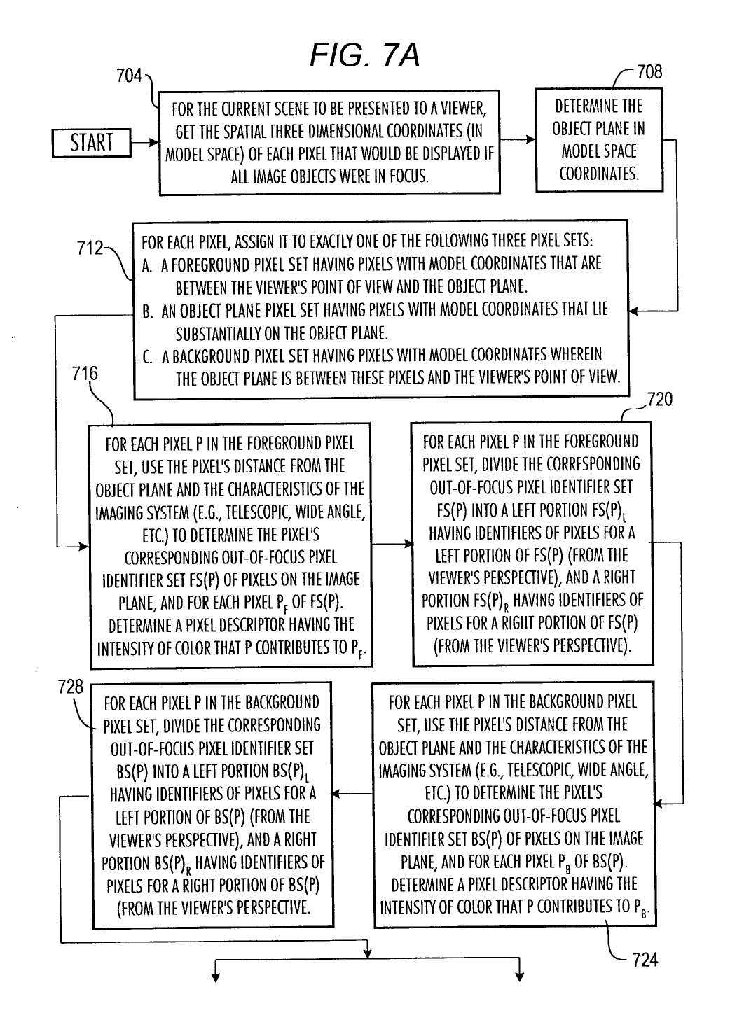

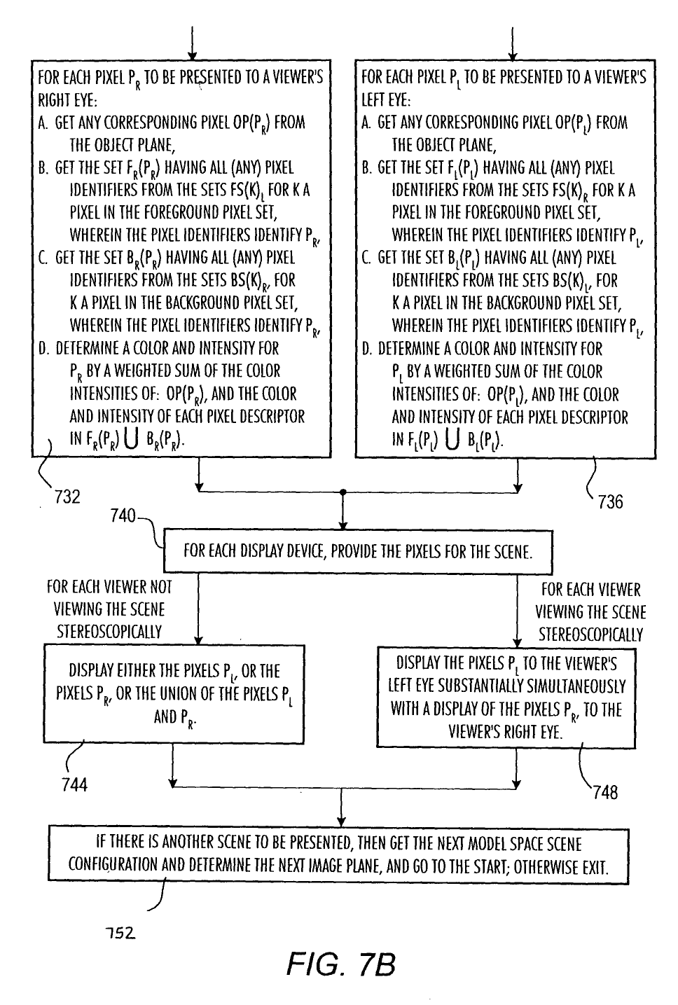

FIG. 7 is a high level flowchart the steps performed by at least one embodiment of the present invention for rendering one or more three dimensionally enhanced scenes. In step 704, the model coordinates of pixels for a “current scene” (i.e., a graphical scene being currently processed for defocusing the foreground and the background, and, adding three dimensional visual effects) are obtained. In step 708, a determination of the object plane in model space is made. In step 712, for each pixel in the current scene, the pixel (previously denoted IM pixel) is assigned to one of three pixel sets, namely:

1. A foreground pixel set having pixels with model coordinates that are between the viewer's point of view and the object plane;

2. An object plane or in-plane set have pixels with model coordinates that lie substantially on the object plane; and.

3. A background pixel set having pixels with model coordinates wherein the object plane is between these pixels and viewer's point of view.

Subsequently, in step 716, for each pixel P in the foreground pixel set, determine the pixel's out-of-focus image extent on the image plane. That is, generate the set FS(P) of pixel identifiers for identifying each pixel on the image plane that will be effected by the defocusing of P. Note that this determination is dependent upon both the characteristics of the type of imaging being performed (such as telescopic, wide angle, etc.), and the distance that the pixel P is from the object plane. Additionally, for each image plane pixel P_{F} identified in FS(P), determine a corresponding pixel descriptor having the spectral intensity of color that P (more precisely, the defocused extent of P) contributes to the pixel P_{F} of the image plane.

In step 720, for each pixel P in the foreground pixel set, perform Step (d) previously described for dividing the corresponding out-of-focus image plane extent, FS(P), into, e.g., a left portion FS(P)_{L} and a right portion FS(P)_{R} (from the viewer's perspective).

In step 724, for each pixel P in the background pixel set, determine the pixel's out-of-focus image extent on the image plane. That is, generate the set BS(P) of pixel identifiers for identifying each pixel on the image plane that will be effected by the defocusing of P. Note that as with step 716, this determination is dependent upon both the characteristics of the type of imaging being performed (such as telescopic, wide angle, etc.), and the distance that the pixel P is from the object plane. Additionally, for each image plane pixel P_{B} identified in BS(P), determine a corresponding pixel descriptor having the spectral intensity of color that P (more precisely, the focused extent of P) contributes to the pixel P_{B} of the image plane.

In step 728, for each pixel P in the background pixel set, perform Step (d) previously described for dividing the corresponding out-of-focus image plane extent, BS(P), into, e.g., a left portion BS(P)_{L} and a right portion BS(P)_{R} (from the viewer's perspective).

Subsequently, steps 732 and 736 are performed (parallelly, asynchronously, or serially). In step 732, a version of the current scene (i.e., a version of the image plane) is determined for displaying to the viewer's right eye and in step 736, a version of the current scene (i.e., also a version of the image plane) is determined for displaying to the viewer's left eye. In particular, in step 732, for determining each pixel P_{R} to be presented to the viewer's right eye, the following substeps are performed:

732(a) Determine any corresponding pixel OP(P_{R}) from the object plane that corresponds to the display location of P_{R};

732(b) Obtain the set FR(P_{R}) having all (i.e., zero or more) pixel identifiers, ID, for the from the left portion sets FS(K)_{L} for K a pixel in the foreground pixel set, wherein each of the pixel identifiers ID identify the pixel P_{R}. Note that each FS(K)_{L} is determined in step 720;

732(c) Obtain the set BR(P_{R}) having all (i.e., zero or more) pixel identifiers, ID, from the right portion sets BS(K)_{R} for K a pixel in the background pixel set, wherein each of the pixel identifiers ID identify the pixel P_{R}. Note that each BS(K)_{R} is determined in step 728; and

732(d) Determine a color and intensity for P_{R} by computing a weighted sum of the color intensities of: OP(P_{R}), and the color and intensity of each pixel descriptor in F_{R}(P_{R})∪B_{R}(P_{R}). In at least one embodiment, the weighted sum is determined so that the resulting spectral intensity of P_{R} is substantially the same as the initial spectral intensity of the uniquely corresponding pixel from model space prior to any defocusing. Thus, for example, assume the pixel display location of P_{R} (on the image plane) is a unique projection of a background pixel Pₘ in model space prior to any defocusing, and Pₘ has a spectral intensity of 66 (on a scale of, e.g., 0 to 256). Also assume that it is determined (in step 720) that there are two background left portion sets BS(K₁)_{L} and BS(K₂)_{L} having, respectively, pixel identifiers ID₁ and ID₂ each identifying the image plane location of P_{R}, and that the spectral intensity contribution to the pixel location of P_{R} from the (model space) pixels identified by ID₁ and ID₂ is respectively 14 and 23. Further, assume that there is one background right portion set BS(K₃)_{R} (determined in step 728) having a pixel identifier ID₃ also identifying the image plane location of P_{R} wherein the spectral intensity contribution of the pixel location of P_{R} is 55. Then the color and spectral intensity of P_{R} is:

$$66 * ( \frac{66}{158} * {c}_{m} + \frac{14}{158} * {c}_{1} + \frac{23}{158} * {c}_{2} + \frac{55}{158} * {c}_{3} ) ,$$

wherein 66+14+23+55=158 and cₘ, c₁, c₂, and c₃ are the color designations for Pₘ, K₁, K₂, and K₃.

Note that step 736 can be described similarly to step 732 above by merely replacing “R” subscripts with “L” subscripts, and “L” subscripts with “R” subscripts.

In step 740 the pixels determined in steps 732 and/or 736 are supplied to one or more viewing devices for viewing the current scene by one or more viewers. Note that such display devices may include stereoscopic and non-stereoscopic display devices. In particular, for viewers viewing the current scene non-stereoscopically, step 744 is performed wherein the display device either displays only the pixels determined by one of the steps 732 and 736, or alternatively both right eye and left eye versions of the current scene may be displayed substantially simultaneously (e.g., by combining the right eye and left eye versions as one skilled in the art will understand). Note, however, that the combining of the right eye and left eye versions of the current scene may also be performed in step 740 prior the transmission of any current scene data to the non-stereoscopic display devices.

Step 748 is performed for providing current scene data to each stereoscopic display device to be used by some viewer for viewing the current scene. However in this step, the pixels determined in step 732 are provided to the right eye of each viewer and the pixels determined in step 736 are provided the left eye of each viewer. In particular, for each viewer, the viewer's right eye is presented with the right eye version of the current scene substantially simultaneously with the viewer's left eye being presented with the left eye version of the current scene (wherein “substantially simultaneously” implies, e.g., that the viewer can not easily recognize any time delay between displays of the two versions).

As shown in the patents and patent applications referenced above, a 3D or stereoscopic effect can be obtained by dividing the out-of-focus areas into foreground and background out-of-focus first and second pixel subsets, forming a right set of pixels and a left set of pixels from the subsets and the in-plane pixel set, and, during a first time interval, occluding (or not displaying) the right pixel set and displaying the left pixel set to the left eye of the viewer and, during a second, different time interval, occluding (or not displaying) the left pixel set and displaying the right pixel set to the right eye of the viewer. The alternate occlusion (or display) of the corresponding pixel sets produces a perceived parallax to the user. The near simultaneous viewing of the image pixel sets can produce an image that can be viewed comfortably in 3D with commonly available eyewear.

Finally, in step 752 a determination is made as to whether there is another scene to convert to provide an enhanced three dimensional effect according to the present invention.

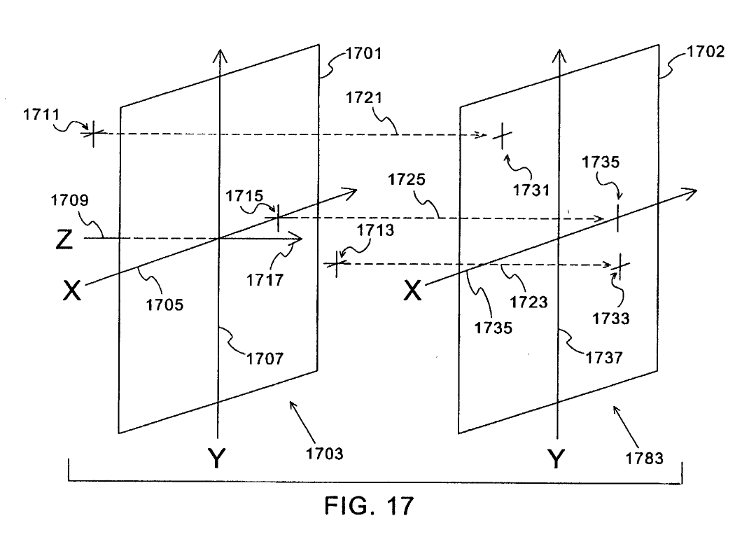

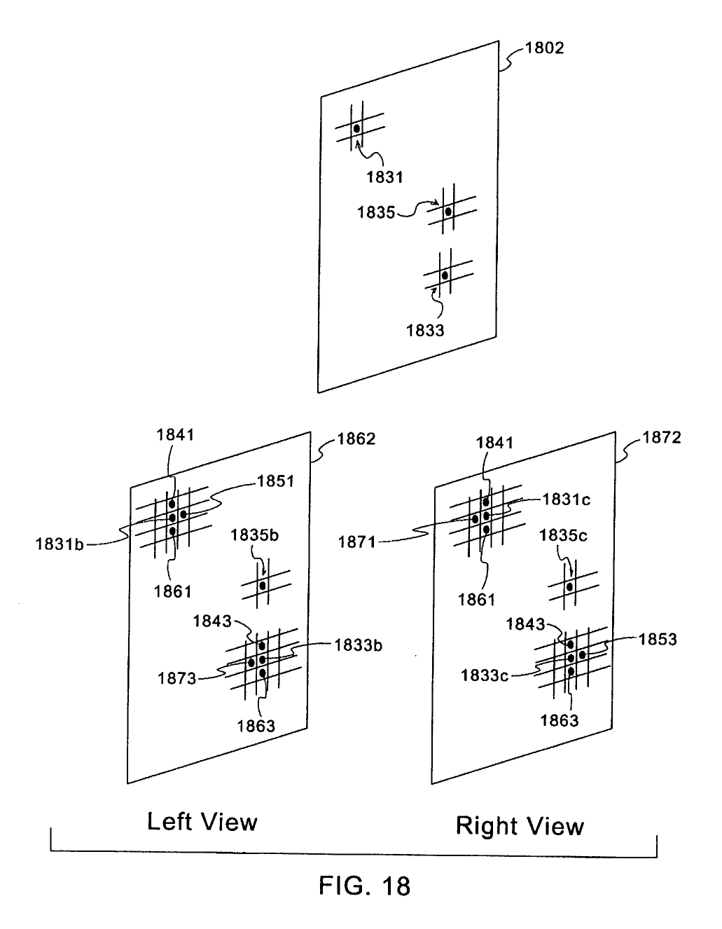

Referring to FIGS. 17 and 18, the steps described in FIG. 7 are graphically depicted. FIG. 17 shows an object plane 1701 that is located in object space or model space 1703, where that object or model space has three coordinates as denoted by the X-axis 1705, the Y-axis 1707, and the Z-axis 1709. The X-axis and Y-axis denote a plane 1701 that is perpendicular or approximately perpendicular to the point of view of a viewer (not shown) whose point of view lies along the Z-axis 1709 in the direction of the arrow 1717.

A background point 1711 is further form the viewer than is the object plane 1701. A foreground point 1713 is closer to the viewer than is the object plane 1701. A third point 1715 is in the object plane, and in this illustration, lies along the X-axis 1705. Background point 1711 and the foreground point 1715 would be out-of-focus in a physical world, whereas the in-plane point 1715 would be in-focus in a physical world. In object or model space 1703, the points represent locations that are neither in nor out of focus.

FIG. 17 also shows an image plane 1702 (the plane for viewing a representation of the object space, also known as a display surface). The image plane lies in 2D space 1783 (that is, the image plane has only an X-axis 1735 and a Y-axis 1737). The image plane 1702 is parallel or approximately parallel to the object plane 1701. The background point 1711 is projected, as shown by dashed projection line 1721, along a path parallel or approximately parallel to the Z-axis 1709, to an image plane point 1731 that represents in 2D space, on the image plane 1702, the location of the 3D space background point 1711. The foreground point 1713 is projected, as shown by dashed projection line 1723, along a path parallel or approximately parallel to the Z-axis 1709, to an image plane point 1733 that represents in 2D space, on the image plane 1702, the location of the 3D space foreground point 1713. The in-object-plane point 1715 is projected, as shown by dashed projection line 1725, along a path parallel or approximately parallel to the Z-axis 1709, to an image plane point 1735 that represents in 2D space, on the image plane 1702, the location of the 3D space in-object-plane point 1715.

We show projection lines 1721, 1725, and 1713 as parallel to the Z-axis for simplicity of description. In actual practice, the projection lines will typically model the physical principles of optics. Using those principles, the lines would converge through a lens, or a simulation of a lens, and would focus on the image-plane 1702. Such a single-point of view model will yield an in-focus image, like a photograph, where each pixel contains in-focus information. Thus, in the image plane each pixel contains unique image information and would not be derived from an overlapping of competing pixels. It is from this in-focus image representation that defocusing of the image information in at least some of the pixels proceeds.

FIG. 18 shows pixels 1831, 1833, and 1835 on the image plane 1802, that represent the corresponding points 1731,1733, and 1735 of FIG. 17. Pixel 1831 of FIG. 18 is located at the same X,Y coordinates (or pixel location) (not shown) as the point 1731 of FIG. 17. Pixel 1833 of FIG. 18 is located at the same X,Y coordinates (or pixel location) (not shown) as the point 1733 of FIG. 17. And pixel 1835 of FIG. 18 is located at the same X,Y coordinates (or pixel location) (not shown) as the point 1735 of FIG. 17. Without changing the coordinates of any of the image plane pixels, the following pixel; location in the left-view image plane 1862. The copy of pixel 1831b has three pixels (in this example) added to it, one adjacent and above 1841, one adjacent and below 1861, and one adjacent and to the right 1851, and then all four pixels are adjusted to a new color intensity value that is, in one methodology, no more than one fourth of the original (saved) color intensity of pixel 1831. Pixel 1833 is copied from image plane 1802 to the same pixel location in the left-view image plane 1862 and its color intensity saved. Pixel copy 1833b has three pixels (in this example) added to it, one adjacent and above 1843, one adjacent and below 1863, and one adjacent and to the left 1873, and then all four pixels are adjusted to a new color intensity value that is, in one methodology, no more than one fourth of the original (saved) color intensity of pixel 1833. Pixel 1835 is copied from image plane 1802 to the same location on the left-view image plane 1862, wherein that copy 1835b is left unchanged from the original.

Second, in FIG. 18, the right view is generated. The color intensity of pixel 1831 is saved. Pixel 1831 is copied from image plane 1802 to the same pixel location on the right-view image plane 1872. The copy of pixel 1831c has three pixels (in this example) added to it, one adjacent and above 1841, one adjacent and below 1861, and one adjacent and to the left 1871, and then all four pixels have are adjusted to a new color intensity value that is, in one methodology, no more than one fourth of the original (saved) color intensity of pixel 1831. Pixel 1833 is copied from image plane 1802 to the same pixel location in the right-view image plane 1862 and its color intensity saved. Pixel copy 1833c has three pixels (in this example) added to it, one adjacent and above 1843, one adjacent and below 1863, and one adjacent and to the right 1853, and then all four pixels have are adjusted to a new color intensity value that is, in one methodology, no more than one fourth of the original (saved) color intensity of pixel 1833. Pixel 1835 is copied from image plane 1802 to the same pixel location on the right-view image plane 1872, wherein that copy 1835c is left unchanged from the original.

Although we say that the sum of color intensity of the new four pixels must not be more than the original color intensity of the original pixel, that restriction should not be taken as limiting. Clearly, if the sum is greater or amplified to be greater, that greater sum can be employed to generate a scene that is brighter than the original scene, or if the sum is greater, that greater sum can be used to produce special visual effects.

Both views are then displayed during different, possibly overlapping, time intervals, the left-view image plane 1862 to the left eye, and the right-view image plane 1872 to the right eye of the viewer so that a 3D image is perceived. Or the views are then displayed during different, possibly overlapping, time intervals, the left-view image plane 1862 to the right eye, and the right-view image plane 1872 to the left eye of the viewer so that a depth-reversed (Z-axis inverted) 3D image is perceived. Or the two image planes 1862 and 1872 are both shown simultaneously (in the same time interval) to both eyes of the viewer so that a 2D image is perceived.

The two images planes 1862 and 8172 are displayed to the two eyes of the viewer either simultaneously or sequentially. The sequential rate of display is usually performed within the limits of human persistence of vision (within about 5 milliseconds), but may be performed at a slower rate so that defects in the implementation may be discovered.

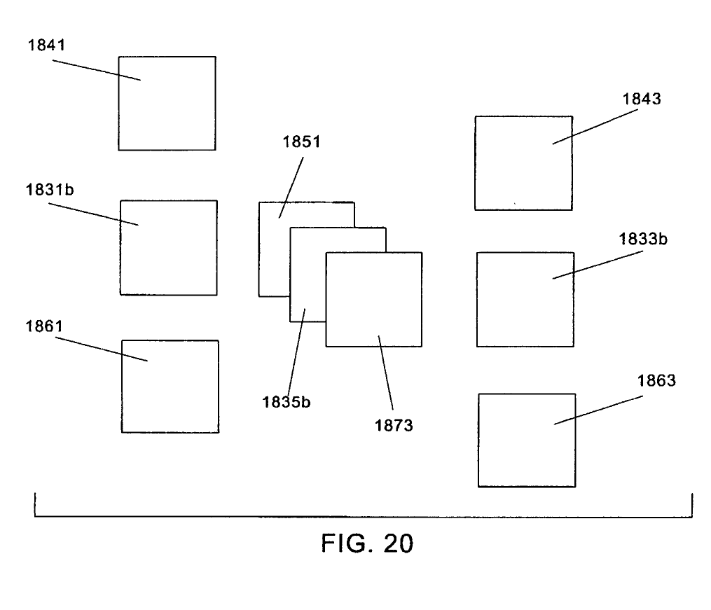

FIG. 20 illustrates that the pixels of FIG. 18 may overlap. The out-of-focus left-view background point, as represented by pixel 1831b, is shown as rendered by pixels 1841, 1831b, 1861, and 1851. The out-of-focus left-view foreground point, as represented by pixel 1833b, is shown as rendered by pixels 1843, 1833b, 1863, and 1873. The in-focus point is represented by pixel 1835b. As shown, foreground pixel 1873 overlaps image-plane pixel 1835b, which in turn overlaps background pixel 1851. When such overlaps occur, the following steps are undertaken:

If an in-focus pixel overlaps one of a background out-of-focus pixel set's pixel, the in-focus pixel typically masks the out-of-focus pixel set's pixel.

If an out-of-focus pixel set's pixel overlaps another out-of-focus pixel set's pixel (for example a foreground pixel overlaps a background pixel, two foreground pixels overlap, or two background pixels overlap), the color intensities of the two pixels are typically averaged typically with a weighted average where the weight is typically based on the number of pixels in each set (e.g. if pixel A is a member of a set of 5 pixels, and if pixel B is a member of a set of 3 pixels, pixel A would weigh 20% and pixel B would weigh 33%, which would yield a new pixel that is (B+(A*0.6))/2). That is, the greater the number of pixels in a set, the less each pixel of the set contributes to the color-intensity of any given overlapping pixel.

If a foreground out-of-focus pixel set's pixel overlaps an in-focus point's pixel the same weighted average, as above, is used, but where the in-focus point's pixel represents a set of one pixel.

Although we speak of a weighted average, other formulas may also be used to compute the contribution of any given pixel to the resulting image at that pixel point when multiple pixels overlap. Those skilled in the mathematical arts will quickly be able to determine other formulas (e.g. simple average, non-linear weighting based on simulated optical properties, etc.) that can suitably replace weighted averaging, and such other formulas shall still be considered a part of this patent.

The foregoing discussion of the invention has been presented for purposes of illustration and description. Further, the description is not intended to limit the invention to the form disclosed herein. Consequently, variation and modification commensurate with the above teachings, within the skill and knowledge of the relevant art, are within the scope of the present invention. The embodiment described hereinabove is further intended to explain the best mode presently known of practicing the invention and to enable others skilled in the art to utilize the invention as such, or in other embodiments, and with the various modifications required by their particular application or uses of the invention.

What is claimed is:

1. A method for rendering a 3D view of an image, comprising:
providing an image, the image including at least a first image representation of a first object in the image and being associated with first image information; and
defocusing the first image information.

2. The method of claim 1, further comprising:
displaying at least some of the defocused first image information to a viewer.

3. The method of claim 1, wherein the image further includes at least a second image representation of a second object in the image, wherein the second image representation is associated with second image information, and wherein at least some of the second image information is displayed to a viewer without being defocused.

4. The method of claim 1, wherein the first image information comprises at least a first offset distance from an object plane and the defocusing step comprises:
comparing the first offset distance with a threshold distance;
when the first offset distance exceeds the threshold distance, the defocusing step is performed; and
when the first offset distance is less than the threshold distance, the defocusing step is not performed.

5. The method of claim 1, wherein the providing step includes the step of:
determining an image plane, wherein the first object is in-focus.

6. The method of claim 5, wherein the providing step further includes the step of:
determining an object plane in a model space that is parallel, or approximately parallel, to the image plane.

7. The method of claim 6, wherein the providing step further includes the steps of:
determining a set of pixels that are members of an out-of-focus image set associated with the first image representation and at least a first pixel in that set based on a distance of the a point represented by the pixel from the object plane; and
assigning to the pixel a value based on the point being in front of or behind the object plane relative to the point of view of the viewer.

8. The method of claim 7, wherein the assigning step further includes the steps of:
converting an in-focus pixel that is a member of an out-of-focus image set into an out-of-focus pixel representation by replacing the in-focus pixel with at least two new pixels adjacent to each other;
locating one of the new pixels in the same position as the in-focus pixel; and
adjusting the color intensity components of the new pixels such that they sum to no more than the color intensity of the in-focus pixel.

9. The method of claim 8, wherein the converting step further includes the steps of:
determining if the in-focus pixel has a value, wherein the in-focus pixel is behind the object plane, and horizontally reversing the positions of the adjacent pixels.

10. The method of claim 9, further comprising:
displaying the first new adjacent pixel to the first eye of the viewer; and displaying the second new adjacent pixel to the second eye of the viewer.

11. The method of claim 7, wherein the assigning step further includes the step of:
determining a set of pixels that are members of an in-focus image set and at least a first pixel in that set based on that pixel's correspondence to a point in the object plane.

12. The method of claim 11, wherein the presenting step includes the step of:
displaying the first pixel to both eyes of the viewer.

13. The method of claim 8, wherein the converting step includes the step of rendering the new adjacent pixels horizontally offset from each other.

14. The method of claim 8, wherein the converting step includes the step of rendering the new adjacent pixels diagonally offset from each other.

15. The method of claim 8, wherein the converting step includes the step of rendering the new adjacent pixels vertically offset from each other.

16. The method of claim 8, wherein the converting step includes the step of:
replacing the in-focus pixel with three or more new adjacent pixels; and
displaying the middle adjacent pixel to both eyes.

17. The method of claim 8, wherein the converting step includes the steps of:
determining a location in the image plane where new adjacent pixels overlap other adjacent pixels and where adjacent pixels overlap in-focus pixels; and
adjusting the sum of color intensity components for all such overlapping pixels at any given image plane pixel location to be no greater than the color intensity of the most color intense of all the overlapping pixels at that image plane pixel location.
